(19) United States
(12) Patent Application Publication
(10) Pub. No.: US 2003/0020575 A1
(43) Pub. Date: Jan. 30, 2003

(54) Electromagnetic switching device, for example, contactor

(76) Inventors: Johann Bauer, Ebermannsdorf (DE); Stephan Faber, Kuemmersbruck (DE); Bardo Koppmann, Kaltenbrunn (DE); Manuela Lueftl, Amberg (DE); Markus Meier, Rieden (DE)

Correspondence Address: HARNESS, DICKEY & PIERCE, P.L.C., P.O.BOX 8910, RESTON, VA, 20195, US

(21) Appl. No.: 10/220,198

(22) PCT Filed: Feb. 20, 2001
(86) PCT No.: PCT/DE01/00634

(30) Foreign Application Priority Data
Feb. 29, 2000 (DE) 100 09 496.1

(51) Int. Cl. H01H 67/02

(52) U.S. Cl. 335/132

(57) ABSTRACT

The invention relates to an electromagnetic switching device comprising a housing (1) and a plug-in module (3) which can be inserted into the housing (1) at an insertion point (2) in a direction of insertion (x). The plug-in module (3) holds a magnetic yoke (4), attached to which is a coil unit (20). Two fixing extensions (7), which point respectively to the front and to the rear in relation to the direction of insertion (x), are formed on the magnetic yoke (4). In order to retain the magnetic yoke (4), a retaining bracket (13) extending transversally in relation to the direction of insertion (x), overlaps one of the fixing extensions (7) and engages two retaining tongues (15) from below, said tongues being formed as one-piece with the plug-in module (3).

The present invention relates to an electromagnetic switching device, for example a contactor, having a switching device enclosure and having a withdrawable unit which can be inserted into the switching device enclosure at an insertion point,

with the withdrawable unit holding a magnet yoke to which a coil unit is fitted, by means of which a pull-in force can be exerted on an armature,

with two fastening attachments, which respectively point forward and to the rear seen in the insertion direction, being integrally formed on the magnet yoke.

A switching device such as this is known, for example, from WO 95/12891. In this document, the fastening attachments have through-holes, in which latching hooks engage which are integrally formed on the withdrawable unit.

Further electromagnetic switching devices having a switching device enclosure and having a withdrawable unit which can be inserted into the switching device enclosure are known, for example, from DE 29 01 552 C2 and from DE 32 20 040 C2.

DE 26 20 210 A1 discloses an electromagnetic switching device in which an E-shaped magnet yoke has fastening attachments, which point outward and can be inserted into attachment receptacles in the switching device enclosure, on its outer limbs. A similar disclosure content can be found in DE 42 36 900 A1.

The withdrawable units according to the prior art are all relatively complicated, with a comparatively large number of parts. They thus have a relatively high magnet movement tolerance.

The object of the present invention is to provide an electromagnetic switching device having a switching device enclosure and having a withdrawable unit which can be inserted into the switching device enclosure, in which switching device the withdrawable unit has a simpler design but nevertheless operates reliably, while the magnet movement tolerance of the magnet system remains small.

The object is achieved in that a holding bracket, which extends transversely with respect to the insertion direction, engages over one of the fastening attachments in order to hold the magnet yoke, and engages under two holding tongues, which are integrally formed on the withdrawable unit.

In comparison to WO 95/12891, this results in the magnet yoke being held better and in a simpler fashion, while in comparison to DE 29 01 552 C2 and DE 32 20 040 C2, it results in a considerable saving in individual parts.

If the switching device enclosure has a holding bracket contour on which the holding bracket is supported—directly or via the holding tongues—when the withdrawable unit is inserted, the holding tongues have to be able to withstand only the natural weight of the magnet yoke, but not forces which occur during operation of the switching device.

If the holding tongues are elastically connected to the withdrawable unit, this results in the magnet yoke being fastened in a particularly simple and reliable manner.

The other fastening attachment can in principle likewise be connected to the withdrawable unit via a holding bracket and holding tongues. However, a physically simpler design is achieved if the other fastening attachment is inserted into an attachment receptacle. The attachment receptacle is in this case preferably integrally formed on the withdrawable unit. If the attachment receptacle is arranged in front of the holding bracket, seen in the insertion direction, this results in the withdrawable unit design being physically even simpler.

If the attachment receptacle is designed to be elastic in height, this results in the magnet yoke being held in a clamped manner. If the switching device enclosure has a receptacle contour on which the attachment receptacle is supported when the withdrawable unit is inserted, the attachment receptacle also has to be able to withstand only the natural weight of the magnet yoke.

If the attachment receptacle and the receptacle contour first of all interact via an insertion incline during insertion of the withdrawable unit, this allows the withdrawable unit to be inserted into the switching device enclosure without any snagging and without being subject to tolerances.

If a latching hook for latching the withdrawable unit in the switching device enclosure and an operating element for the latching hook are integrally formed in a sprung manner on the withdrawable unit, no separate latching hook is required for latching. A bar spring preferably engages over the latching hook and/or the operating element in order to provide force assistance.

If the coil unit has a coil and a contact foot which is connected to the coil via an intermediate structure, rests on a foot contact on the withdrawable unit at the side underneath the coil and is at a distance from the coil, this results in the coil unit being supported robustly, in a simple manner.

If the foot contact is arranged recessed in the withdrawable unit, such that the contact foot is recessed in the withdrawable unit, this results in the withdrawable unit having a small physical height.

If the switching device enclosure has a coil contour on which the coil unit is supported when the withdrawable unit is inserted, there is no need for the operating forces to be absorbed by the withdrawable unit. The coil unit can be supported on the coil contour via the contact foot, for example.

If the coil unit is braced by means of the coil contour and the withdrawable unit, the coil is fixed in the switching device enclosure without any play. It can thus not oscillate freely.

If the coil unit has a switch which can be operated by the armature via an operating element, the operating element is mounted in a bearing which is arranged on the coil unit and the switching device enclosure has positioning and supporting elements, by means of which the bearing can be positioned during insertion of the withdrawable unit and is supported when the withdrawable unit is inserted, the operating element can be aligned exactly with respect to the armature in a simple manner.

If the switching device enclosure has a recess on a side opposite the insertion point, via which recess the withdrawable unit can be driven out of the switching device enclosure by means of a driving-out tool, the withdrawable unit can be disconnected from the switching device even in the event of a defect in a comparatively simple manner, namely in particular without complete disassembly of the switching device.

Further advantages and details can be found in the following description of an exemplary embodiment. In this case, illustrated in outline form:

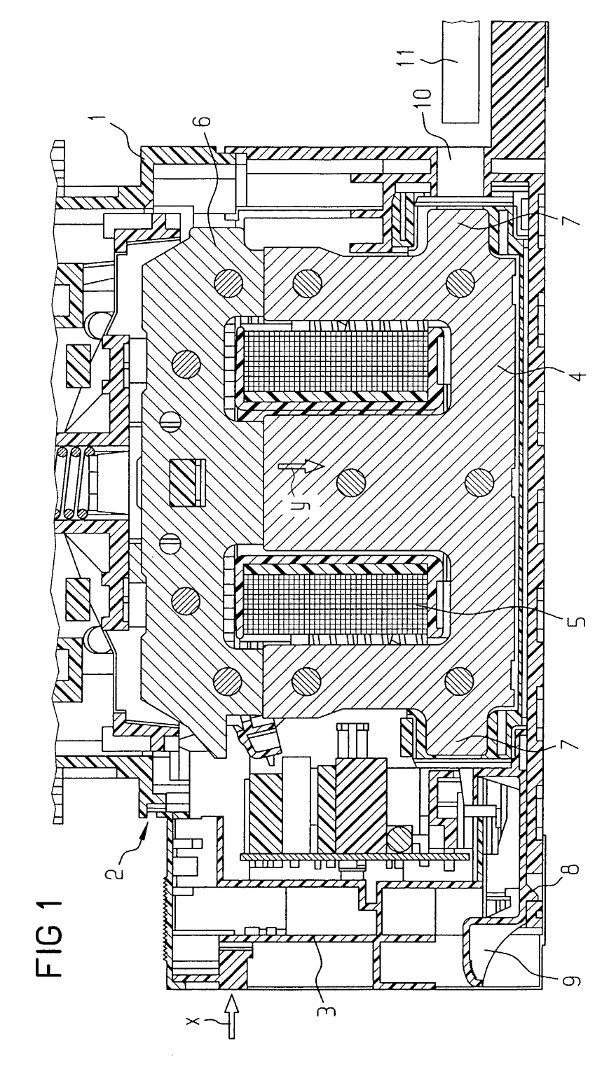

FIG. 1 shows a section through a contactor with a withdrawable unit,

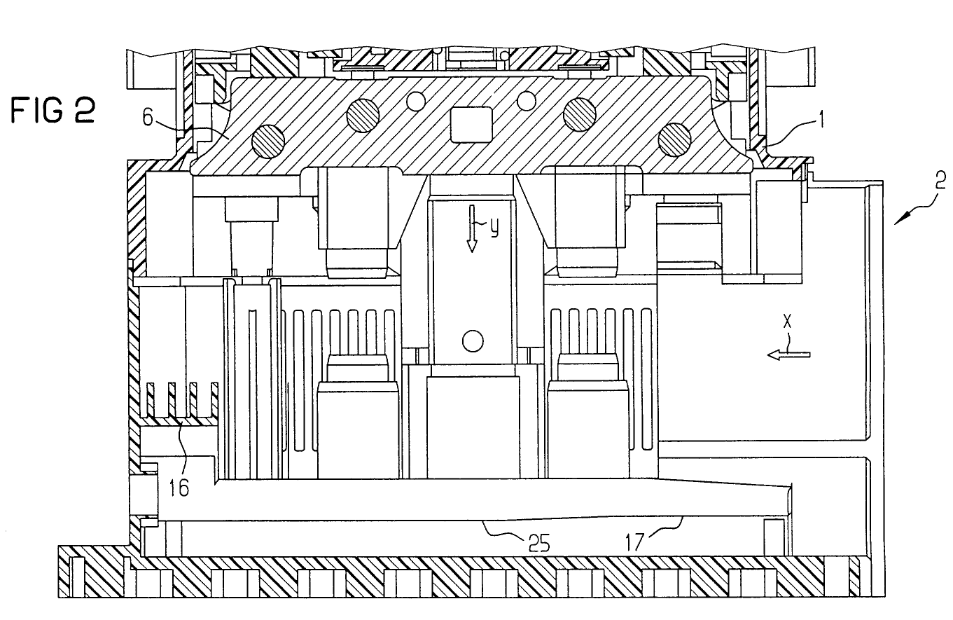

FIG. 2 shows the contactor from FIG. 1 without the withdrawable unit,

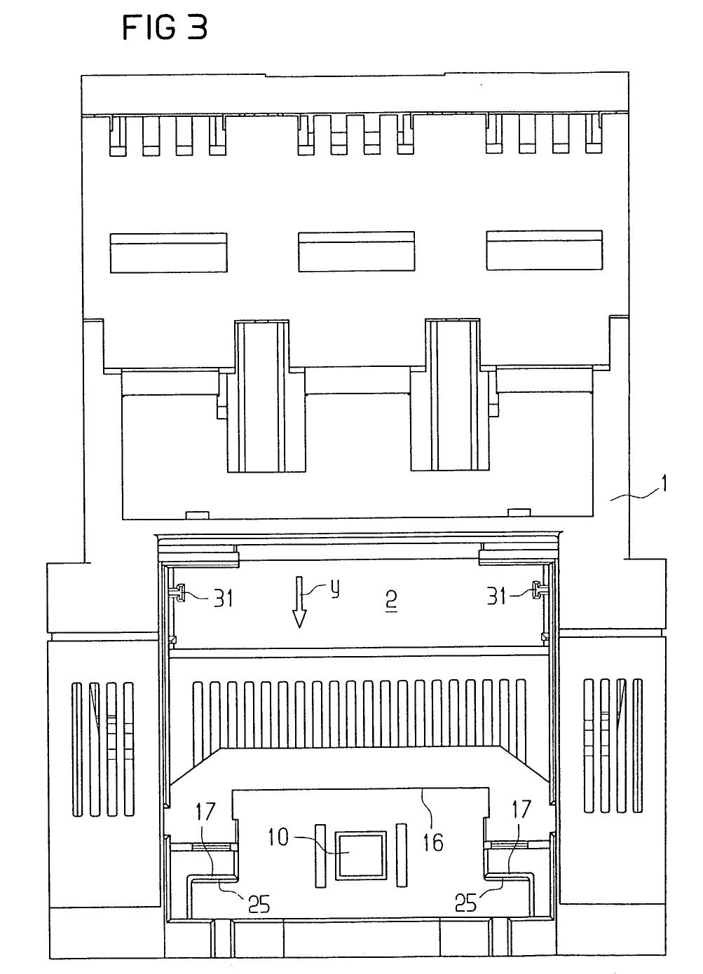

FIG. 3 shows the contactor from FIG. 2 from the front,

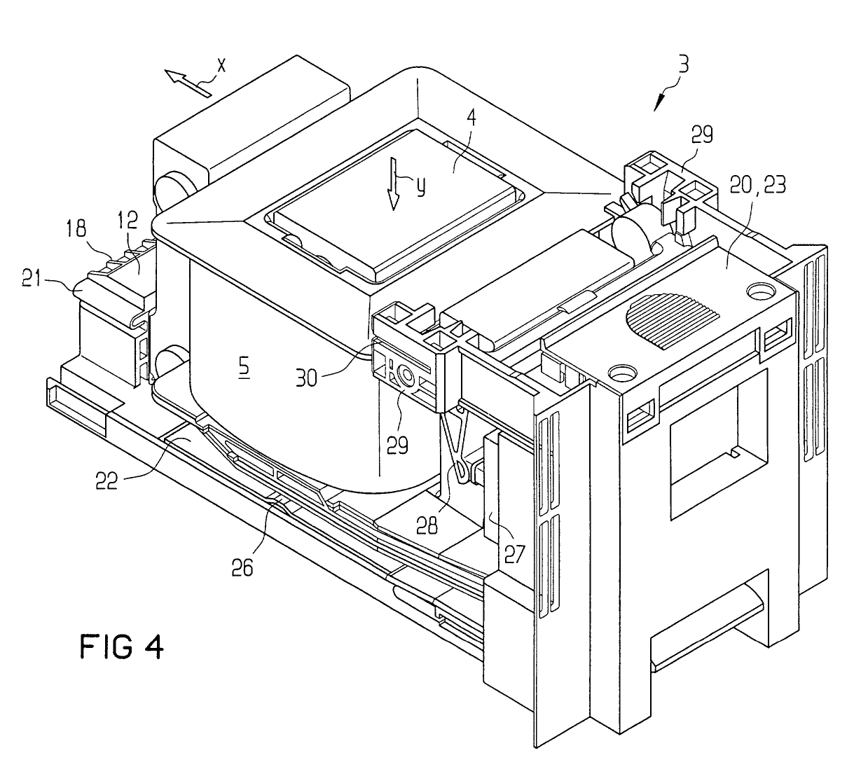

FIG. 4 shows a withdrawable unit with a magnet yoke and a coil unit,

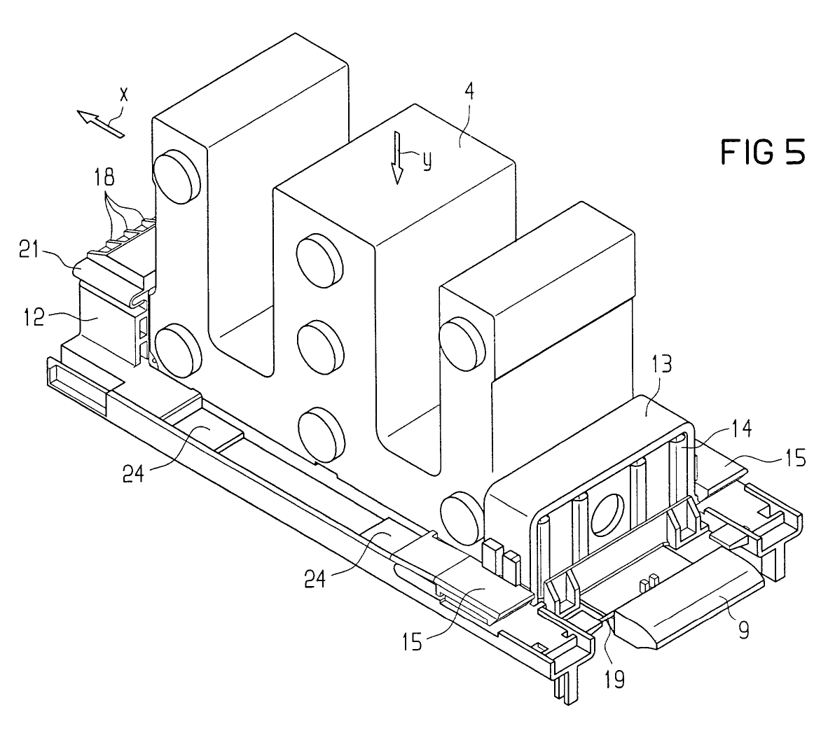

FIG. 5 shows the withdrawable unit from FIG. 4 without a coil unit,

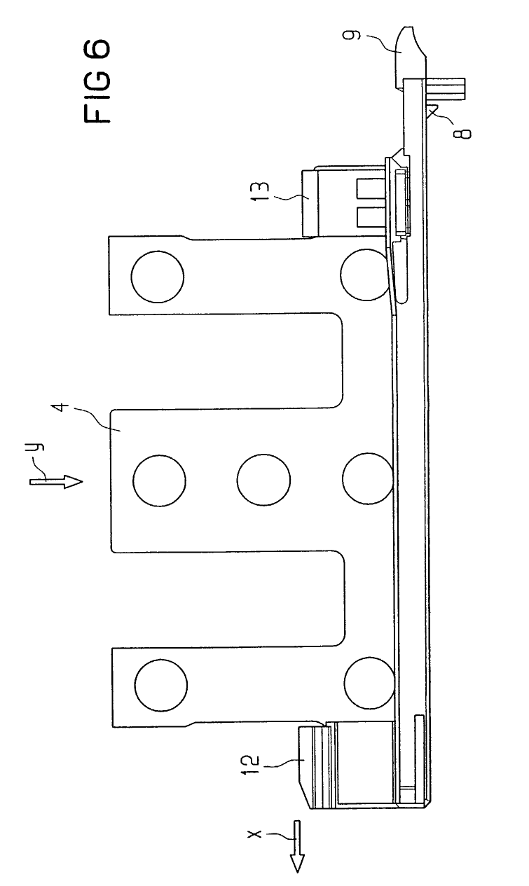

FIG. 6 shows the withdrawable unit from FIG. 5 from the side,

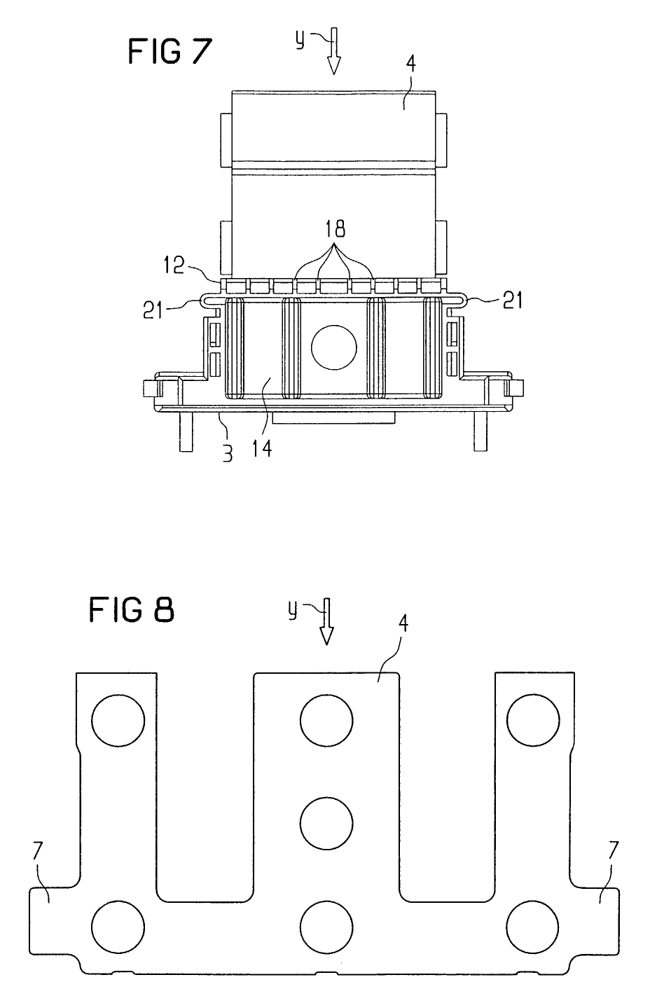

FIG. 7 shows the withdrawable unit from FIG. 5 from the front,

FIG. 8 shows a magnet yoke and

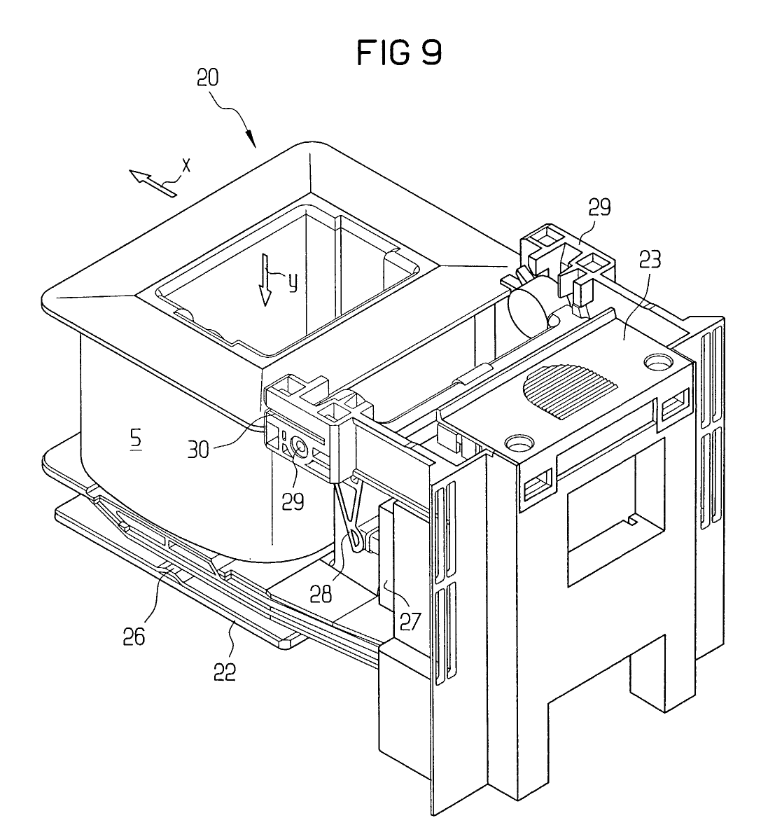

FIG. 9 shows a coil unit.

As shown in FIG. 1, a contactor, as an example of an electromagnetic switching device, has a switching device enclosure 1. A withdrawable unit 3 can be inserted into the switching device enclosure 1 in an insertion direction x at an insertion point 2. The withdrawable unit 3 holds a magnet yoke 4. The magnet yoke 4 and a coil 5 allow a pull-in force to be exerted on an armature 6 in a force direction y. As shown in FIGS. 1 and 8, two fastening attachments 7 are integrally formed on the magnet yoke 4. The fastening attachments 7 respectively point forward and to the rear, seen in the insertion direction x.

As shown in FIG. 1, the withdrawable unit 3 has a latching hook 8, which is provided with an operating element 9. The withdrawable unit 3 can be latched in the switching device enclosure 1 by means of the latching hook 8. The latching hook 8 and the operating element 9 are integrally formed on the withdrawable unit 3 in a sprung manner. In order to withdraw the withdrawable unit 3 from the switching device enclosure 1, the operating element 9 is just raised, and the withdrawable unit 3 is withdrawn from the switching device enclosure 1 using the operating element 9.

For a situation where the withdrawable unit 3 cannot be withdrawn owing to a defect, the switching device enclosure 1 has a recess 10. As can be seen, the recess 10 is arranged on a side of the switching device enclosure 1 which is opposite the insertion point 2. A schematically illustrated driving-out tool 11, for example a punch, can be attached to the front fastening attachment 7 of the magnet yoke 4 via the recess 10, so that the withdrawable unit 3 can be driven out of the switching device enclosure 1 using a hammer.

As shown in FIG. 5, the magnet yoke 4 is held by an attachment receptacle 12 and holding bracket 13. The attachment receptacle 12 is arranged in front of the holding bracket 13, seen in the insertion direction x. It is integrally formed on the withdrawable unit 3. As shown in FIGS. 5 and 7, the attachment receptacle 12 has U-shaped expansion elements 21. It is thus designed such that it is elastic in height.

Damping parts 14, for example composed of rubber, are fitted to the fastening attachments 7 in order to attach the magnet yoke 4 to the withdrawable unit 3. One of the fastening attachments 7 is then inserted into the attachment receptacle 12.

The holding bracket 13 extends essentially transversely with respect to the insertion direction x over the other fastening attachment 7. It engages over this fastening attachment 7. Furthermore, the holding bracket 13 engages under two holding tongues 15, which are integrally formed in an elastic manner on the withdrawable unit 3.

As shown in FIG. 2, the switching device enclosure 1 has a receptacle contour 16 and a holding bracket contour 17. When the withdrawable unit 3 is inserted in the switching device enclosure 1, the attachment receptacle 12 is supported on the receptacle contour 16, and the holding bracket 13 is supported on the holding bracket contour 17. According to the exemplary embodiment, the holding bracket 13 is in this case supported on the holding bracket contour 17 via the holding tongues 15. If the holding bracket 13 is sufficiently wide, it could, however, also be supported directly on the holding bracket contour 17. The supports mean that the magnetic forces which occur during switching of the contactor are introduced directly into the switching device enclosure 1, rather than into the withdrawable unit 3.

The attachment receptacle 12 and the receptacle contour 16 first of all interact via an insertion incline 18 during insertion of the withdrawable unit 3, which insertion incline 18 is arranged, according to the exemplary embodiment, on the attachment receptacle 12. This makes it considerably easier to insert the withdrawable unit 3 into the switching device enclosure 1.

The insertion incline 18 can be seen particularly clearly in FIGS. 5 and 6. It can also be seen from FIG. 5 that a bar spring 19 engages over the latching hook 8 and its operating element 9, in order to provide force assistance.

As shown in FIG. 4, a coil unit 20 is fitted to the magnet yoke 4. In addition to the coil 5, the coil unit 20 also has a contact foot 22. The contact foot 22 is connected to the coil 5 via an intermediate structure 23. The contact foot 22 is arranged at the side underneath the coil 5 and, as can be seen, is at a distance from the coil 5. It rests on a foot contact 24 on the withdrawable unit 3. The foot contact 24 is arranged recessed in the withdrawable unit 3, so that the contact foot 22 is recessed in the withdrawable unit 3.

As shown in FIG. 2, the switching device enclosure 1 has a coil contour 25, on which the coil unit 20 is supported when the withdrawable unit 3 is inserted. In this case, the coil unit 20 is supported on the coil contour 25 via the contact foot 22. As can be seen, the coil unit 20 is in this case braced by the coil contour 25 by means of a projection 26, which is arranged on the contact foot 22.

The coil unit 20 has a switch 27, which can be operated by the armature 6 via an operating element 28. The operating element 28 is mounted in a bearing 29, which is arranged on the coil unit 20. Grooves 30 with a T-shaped cross section are arranged on the outsides of the bearing 29 and, during insertion of the withdrawable unit 3, interact with positioning and supporting elements 31, which likewise have a T-shaped cross section. The interaction of the grooves 30 with the positioning and supporting elements 31 results in the bearing 29 being positioned during insertion of the withdrawable unit 3, and being supported when the withdrawable unit 3 is inserted.

1. An electromagnetic switching device, for example a contactor, having a switching device enclosure (1) and having a withdrawable unit (3) which can be inserted into the switching device enclosure (1) in an insertion direction (x) at an insertion point (2),
with the withdrawable unit (3) holding a magnet yoke (4) to which a coil unit (20) is fitted, by means of which a pull-in force can be exerted on an armature (6),
with two fastening attachments (7), which respectively point forward and to the rear seen in the insertion direction (x), being integrally formed on the magnet yoke (4), and
with a holding bracket (13), which extends transversely with respect to the insertion direction (x), engaging over one of the fastening attachments (7) in order to hold the magnet yoke, and engaging under two holding tongues (15), which are integrally formed on the withdrawable unit (3).

2. The switching device as claimed in claim 1, characterized in that the switching device enclosure (1) has a holding bracket contour (17) on which the holding bracket (13) is supported—directly or via the holding tongues (15)—when the withdrawable unit (3) is inserted.

3. The switching device as claimed in claim 1 or 2, characterized in that the holding tongues (15) are elastically connected to the withdrawable unit (3).

4. The switching device as claimed in claim 1, 2 or 3, characterized in that the other fastening attachment (7) is inserted into an attachment receptacle (12).

5. The switching device as claimed in claim 4, characterized in that the attachment receptacle (12) is integrally formed on the withdrawable unit (3).

6. The switching device as claimed in claim 4 or 5, characterized in that the attachment receptacle (12) is arranged in front of the holding bracket (13), seen in the insertion direction (x).

7. The switching device as claimed in claim 4, 5 or 6, characterized in that the attachment receptacle (12) is designed to be elastic in height.

8. The switching device as claimed in one of claims 4 to 7, characterized in that the switching device enclosure (1) has a receptacle contour (16) on which the attachment receptacle (12) is supported when the withdrawable unit (3) is inserted.

9. The switching device as claimed in claim 8, characterized in that the attachment receptacle (12) and the receptacle contour (16) first of all interact via an insertion incline (18) during insertion of the withdrawable unit (3).

10. The switching device as claimed in one of the preceding claims, characterized in that a latching hook (8) for latching the withdrawable unit (3) in the switching device enclosure (1), and a operating element (9) for the latching hook (8), are integrally formed in a sprung manner on the withdrawable unit (3).

11. The switching device as claimed in claim 10, characterized in that a bar spring (19) engages over the latching hook (8) and/or the operating element (9) in order to provide force assistance.

12. The switching device as claimed in one of the preceding claims, characterized in that the coil unit (20) has a coil (5) and a contact foot (22), which is connected to the coil (5) via an intermediate structure (23), and in that the contact foot (22) rests on a foot contact (24) on the withdrawable unit (3) at the side underneath the coil (5), and is at a distance from the coil (5).

13. The switching device as claimed in claim 12, characterized in that the foot contact (24) is arranged recessed in the withdrawable unit (3), such that the contact foot (22) is recessed in the withdrawable unit (3).

14. The switching device as claimed in one of the preceding claims, characterized in that the switching device enclosure (1) has a coil contour (25) on which the coil unit (20) is supported when the withdrawable unit (3) is inserted.

15. The switching device as claimed in claims 12 and 14 or 13 and 14, characterized in that the coil unit (20) is supported on the coil contour (25) via the contact foot (22).

16. The switching device as claimed in claim 14 or 15, characterized in that the coil unit (20) is braced by means of the coil contour (25).

17. The switching device as claimed in one of the preceding claims, characterized in that the coil unit (20) has a switch (27), which can be operated by the armature (6) via an operating element (28), in that the operating element (28) is mounted in a bearing (29) which is arranged on the coil unit (20), and in that the switching device enclosure (1) has positioning and supporting elements (31), by means of which the bearing (29) can be positioned during insertion of the withdrawable unit (3), and is supported when the withdrawable unit (3) is inserted.

18. The switching device as claimed in one of the preceding claims, characterized in that the switching device enclosure (1) has a recess (10) on a side opposite the insertion point (2), via which recess (10) the withdrawable unit (3) can be driven out of the switching device enclosure (1) by means of a driving-out tool (11).
